(19) United States
(12) Patent Application Publication
(10) Pub. No.: US 2015/0334186 A1
(43) Pub. Date: Nov. 19, 2015

(54) Coax Adaptor for Ethernet Physical Layer Transceiver

(71) Applicant: Safeciety LLC, Irvine, CA (US)

(72) Inventor: Shidong Chen, Irvine, CA (US)

(21) Appl. No.: 14/712,904

(22) Filed: May 14, 2015

Related U.S. Application Data
(60) Provisional application No. 61/993,514, filed on May 15, 2014.

(51) Int. Cl. H04L 29/08; H04L 12/721; H01R 24/64; H04N 7/18

(52) U.S. Cl. CPC H04L 67/12; H04N 7/183; H04L 45/66; H01R 24/64; H01R 2107/00

(57) ABSTRACT

There is a need to deploy the IP (Internet Protocol) video surveillance camera over both Ethernet cable and coax cable. The present invention presents the IP video surveillance camera with dual Ethernet cable interface and coax cable interface by using the presented dual physical layer transceiver. The dual physical layer transceiver includes a conventional E-PHY (Ethernet physical layer transceiver) and a lightweight coax adapter to allow low cost. The coax adapter typically exists in series between the active E-PHY and coax cable, keeps part of functions in E-PHY effective, and adapts the E-PHY signal onto coax cable and vice versa. The conventional E-PHY alone provides the Ethernet cable interface while the conventional E-PHY is combined with the coax adaptor to provide the coax cable interface. Further, the present invention presents methods to relay Ethernet over coax by using a pair of the coax adaptors.

This application refers to the prior provisional application under application No. U.S. 61/993,514 filed on May 15, 2014.

### BACKGROUND OF THE INVENTION

1. Field of Invention

The present invention relates to the IP (Internet Protocol) video surveillance camera with dual Ethernet cable (cat5/6 UTP cable) and coax cable interface (referred as dual cable interface IP camera, dual interface camera, or Dual-I/F camera). The present invention also relates to transmission of Ethernet over coax cable or transmission of IP over coax cable.

2. Background

In the HD (high definition) IP video surveillance systems, typically multiple HD IP cameras are connected with one NVR (network video recorder) or DVR (digital video recorder) via cable networks. Each HD IP camera transmits its video to the NVR over the connecting cables. The NVR often displays the camera videos instantly to monitor live scenes in the field of view of cameras and records the camera videos for later playback as well.

Many HD IP cameras are deployed over Ethernet cables. The HD IP cameras often employ heavyweight video compression technology such as H.264 to compress the source HD video into the compressed HD video at a bit rate about 10 Mbps or below. The compressed HD video is wrapped in IP packets, and further into forward Ethernet MAC (multiple access control) frames. The forward Ethernet MAC frames are sent to the E-PHY (Ethernet physical layer transceiver), where the Ethernet physical layer frames are generated and translated into the E-PHY TX signal. The E-PHY TX signal is typically sent onto the Ethernet cable, such as the CAT 5/6 UTP cable, towards the NVR on the other end. Meanwhile, the E-PHY in the IP camera also receives the incoming E-PHY RX signal from the Ethernet cable, which originates from the NVR, and recovers the backward MAC frames and sends to the processor system in IP camera.

Although many IP cameras are deployed over Ethernet cables, there are needs to deploy IP cameras over coax cables too. For example, as coax cables have been commonly installed and accumulate in the conventional CCTV (Closed-Circuit TV) video surveillance applications in decades, there is the need to deploy the IP cameras over the existing coax cable networks in these legacy CCTV systems. For another example, due the Ethernet standard, the IP video transmission over Ethernet cable is limited to 100 meters, which is insufficient to cover many large video surveillance applications. Deployment over coax can extend the distance beyond the 100-meter limit and serve large video surveillance applications. In order to deploy the IP video surveillance system over both Ethernet and coax cable, there is a need for dual cable interface IP camera and the dual physical layer transceiver that provides the dual cable interface.

Various IP over coax convertors are made to transmit the IP over coax cable. The conventional IP over coax convertors are typically full-blown coax transceivers (referred as coax-PHY), which exist in parallel with the E-PHY and abandon all functions in E-PHY. The prior invention in [1] discloses a SLOC camera that transmits both Ethernet and analog CVBS video signal over coax simultaneously in parallel to the E-PHY typically included in the IP camera. This leads to higher cost. As the video surveillance industry is cost sensitive, there is a need for the dual cable interface physical layer transceiver, which is able to reuse the E-PHY by including the E-PHY as a part of the coax interface, and thus achieves the low cost.

### SUMMARY OF THE INVENTION

The present invention presents the IP (Internet Protocol) video surveillance camera with dual Ethernet cable (cat5/6 cable) interface and coax cable interface, referred as the dual cable interface IP camera, dual interface IP camera, or Dual-I/F camera. The presented dual cable interface IP camera adopts the dual physical layer transceiver that provides the dual Ethernet cable interface and coax cable interface, referred as dual cable interface physical layer transceiver, dual cable interface PHY, or Dual-I/F PHY. The presented Dual-I/F PHY includes a conventional E-PHY (Ethernet physical layer transceiver) and a low-cost lightweight coax adapter. The coax adaptor typically exists in series between the active E-PHY and coax cable, keeps part of functions in E-PHY effective, and adapts the E-PHY signal onto coax cable and vice versa. The conventional E-PHY alone provides the Ethernet cable interface while the conventional E-PHY is combined with the coax adaptor to provide the coax cable interface. Further, the present invention presents methods to relay Ethernet over coax by using a pair of the coax adaptors.

In an embodiment of the present invention where E-PHYs in the dual cable interface PHYs at both camera end and DVR end operate in the 100Base-TX full-duplex mode, the coax adaptors in the dual cable interface PHYs at both ends of the coax cable operate in the full-duplex full-speed mode too, exactly matching the E-PHYs. As an aspect of the present invention, the MAC frame buffering and associated network delay are avoided.

Each coax adaptor is connected via the two-way E-PHY signal with its E-PHY. In the 100Base-TX full-duplex mode, each E-PHY generates a separate E-PHY TX signal to be sent onto one pair of UTP wires, and receives a separate E-PHY RX signal from another pair of UTP wires, both included in the E-PHY signal.

In the embodiment of the present invention, the near-end coax adaptor converts the near-end E-PHY TX signal into the near-end EoC (Ethernet over Coax) TX signal, and sends it onto the coax cable toward the far-end coax adaptor. From the camera's point of view, the near-end refers to camera end, and far-end refers to the DVR end. From the DVR's point of view, the near-end refers to DVR end, and far-end refers to the camera end. Meanwhile, the near-end coax adaptor also receives the EoC RX signal transmitted by far-end coax adaptor through the coax cable. Since the EoC TX output signal and the EoC RX input signal are both connected to the same coax cable, the EoC RX signal from far-end is inevitably mixed together with the near-end EoC TX signal and a mixed EoC signal is formed.

Furthermore, in the embodiment of the present invention, both the near-end and the far-end coax adaptors may transmit freely, in the same frequency band, at same time, without any multiplexed access mechanism applied to control the transmission of the either end. Therefore, the near-end generated EoC TX signal and the EoC RX signal coming from far-end cannot be separated by any multiplexed access mechanism. However, in the embodiment of the present invention, as each coax adaptor knows the clean near-end EoC TX signal it generates in itself, the echo canceller, which is a type of digital adaptive filter, is adopted to estimate the portion of the known near-end EoC TX signal included in the mixed EoC signal. Then the echo canceller subtracts the estimated portion the known near-end EoC TX signal away from the mixed EoC signal, and thus obtains the unknown EoC RX signal from the far-end.

Following the echo canceller, the obtained EoC RX signal is compensated for the cable attenuation, decoded coax encoding and re-encoded Ethernet encoding if needed, fully translated into the E-PHY RX signal and sent to the E-PHY.

In one embodiments of the present invention, the EoC signal is carried through the Ethernet connector, typically an RJ-45 connector to connect with the external coax cable. The RJ-45 connector has four pairs of pins. In an embodiment, the E-PHY operates in 100Base-TX full-duplex mode, where two pairs of pins of the RJ-45 connector are in use, one pair to carry E-PHY TX signal, the other pair to carry the E-PHY RX signal. There are two pairs of pins left unused. Any unused pair of pins can be selected to carry the EoC signal. This is compatible to IEEE 802.3 standard. In another embodiment of the present invention, a pair of pins used by E-PHY can also be selected to carry the EoC signal, as the connection over Ethernet cable and over coax cable do not exist simultaneously but alternatively. This is incompatible with IEEE 802.3 standard. In yet another embodiment of the present invention, the EoC signal is carried through a separate coax connector, such as the BNC connector, to connect with the external coax cable.

In one embodiment of the present invention, an IP camera may generate a CVBS (composite video baseband with synchronization) signal. Either the CVBS signal or the EoC TX signal is selected to pass through the separate coax connector. In a certain embodiment of the present invention, the CVBS signal is selected to pass through the coax adaptor when the existence of far-end coax adaptor is not detected, and the EoC TX signal is selected to pass through when the far-end coax adaptor is detected.

### BRIEF DESCRIPTION OF THE DRAWINGS

FIG. 1 illustrates an embodiment of the presented a dual cable interface IP camera deployed over coax cable in an IP video surveillance system.

FIG. 2 illustrates an embodiment of the dual cable interface IP camera and the dual cable interface physical layer transceiver.

FIG. 3 illustrates an embodiment of the presented coax adaptor.

### DETAILED DESCRIPTION OF THE INVENTION

The principle and embodiments of the present invention will now be described in detail with reference to the drawings, which are provided as illustrative examples so as to enable those skilled in the art to practice the invention. Notably, the figures and examples below are not meant to limit the scope of the present invention to a single embodiment but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

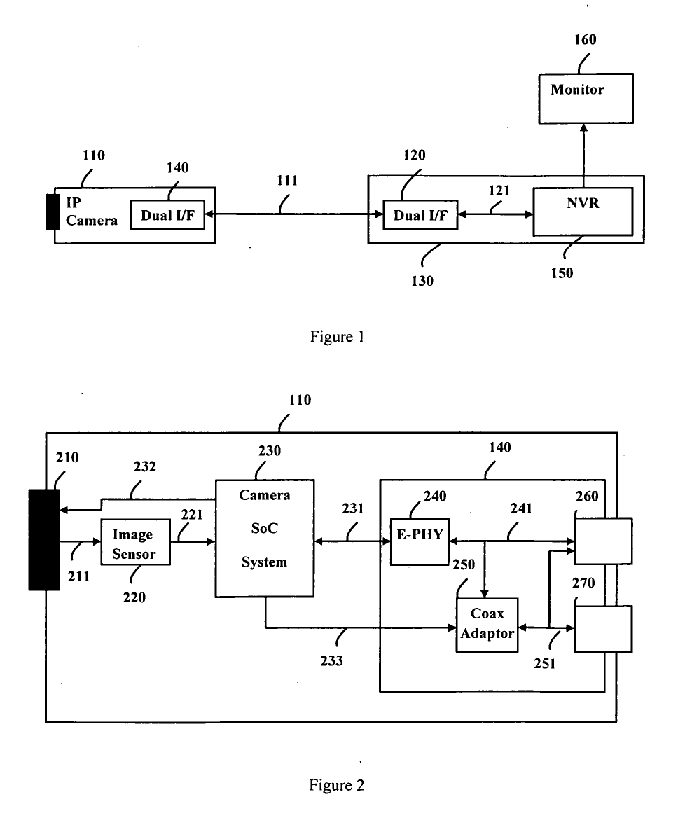

FIG. 1 illustrates an embodiment of the presented a dual cable interface IP camera deployed over coax cable in an IP video surveillance system. The dual cable interface camera 110, through its dual cable interface PHY 140, is connected with the video recorder 130 through the dual cable interface PHY 120, via the coax cable 111. The monitor 160 is connected with the video recorder 130. Such connection is called the coax connection or the EoC connection. Alternatively, the Ethernet cable (Cat5/6) can be used to connect the camera 110 to DVR 130 through the dual cable interface PHY 140 and 120. Such connection is called the Ethernet connection. The Ethernet connection is same as that in the conventional IP video surveillance system. For the purpose of brevity, the coax connection is detailed in following description while the Ethernet connection is skipped.

Inside the DVR 130, the dual cable interface PHY 120 receives the EoC signal for HD video stream over the coax channel 111, recovers the forward Ethernet MAC frames and sends to the NVR 150 via the xMII interface 121, where xMII refers to the MII (media independent interface) interface or its variant such as RMII, SMII, GMII, RGMII and SGMII. It also receives backward Ethernet MAC frames from the NVR 150 via the xMII interface 121, converts it to the backward EoC TX signal and sends it onto the coax channel 111. The NVR 150 is same as the conventional NVR in IP video surveillance system, which usually decode the heavily compressed HD IP video for live monitoring, record the received heavily compressed videos, and playback the recorded videos. The NVR 150 often combines input videos and playback videos together, and generates the combined video signal and sends it to the monitor 160.

FIG. 2 illustrates an embodiment of the dual cable interface IP camera 110 and its dual cable interface PHY 140. The lens system 210 focuses the light rays 211 from the objects in the field of view of the lens system 210 onto the image sensor 220, and produces the raw digital video 221. The processor system (also referred as SoC system) 230 converts the raw digital video 221 into one of its supported video formats, such as 1280×720 pixels in 24/30/60 frames per second, or 1920×1080 pixels in 24/30/60 frames per second. This is called the original source HD video. The camera SoC system 230 further heavily compresses the source HD video down to a bit rate about 10 Mb/S or below. This result is called the compressed HD video. The compressed video is then wrapped in IP packets, further in forward MAC frames, and sent to the dual cable interface PHY 140 via the xMII interface 231. The camera SoC system 230 also receives the MAC frames from the dual interface PHY 140 via the xMII interface 231. Additionally, the camera SoC system 230 can send the signal 232 to control the lens system. The control signal 232 may include the auto-focus control, the iris control and the PTZ (Pan-Tilt-Zoom) control signal. Some control signal, such as the PTZ control signal, may originate from the video recorder 130, and may be carried over the channel 111 or a separate wiring such as RS 485 cable. Optionally, the camera SoC system 230 may generates the CVBS signal 233 and send it to the dual interface PHY 140 too.

Inside the dual cable interface PHY 140, the E-PHY 240 converts the forward MAC frames it receives from the camera SoC system 230 through the xMII interface 231 into the E-PHY TX signal in the two-way E-PHY signal 241. The E-PHY TX signal is sent to the coax adaptor 250 and the Ethernet connector 260. The coax adaptor 250 converts the E-PHY TX signal in signal 241 into the EoC TX signal in signal 251, which is suitable for coax transmission, and sends it to the Ethernet connector 260 or the optional coax connector 270 if it is present in the camera 110. Meanwhile, the coax adaptor 250 also receives the mixed EoC signal in signal 251, coming in from either the Ethernet connector 260 or the coax connector 270 if it exists, and recovers the E-PHY RX signal in signal 241. The E-PHY 240 receives the E-PHY RX signal in signal 241 from the coax adaptor 250, recovers the backward MAC frames from far-end and sends the backward MAC frames to the camera SoC system 230 via the xMII interface 231. As stated above, the signal 251 is the mixed EoC signal. Though either the Ethernet connector 260, or the coax connector 270 if it exists, the mixed EoC signal 251 is connected with the external coax cable 111.

As mentioned before, through the dual interface PHY 140 and 120, either Ethernet connection or EoC connection can be built, but not both at same time. The Ethernet connection and the EoC connection cannot be both logically active at same lime. For example, when both an Ethernet cable with an active E-PHY on the far-end is connected to the Ethernet connector 260 and a coax cable with an active coax adaptor on the far-end is connected to the coax connector 270, one connection has to be disabled logically or electronically. In certain embodiment, the coax connection is disabled whenever the Ethernet connection is established and active. This gives better Ethernet compatibility.

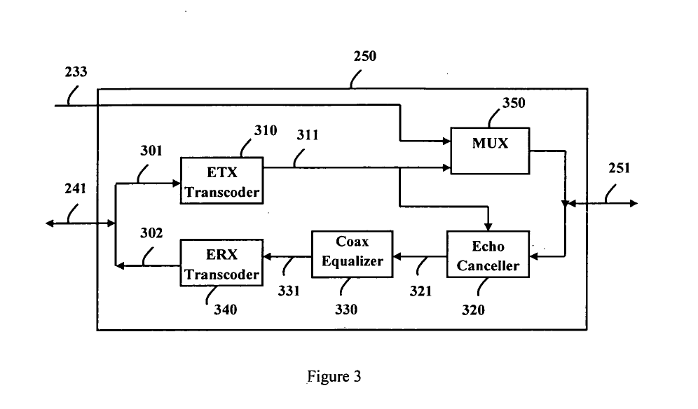

FIG. 3 illustrates an embodiment of the presented coax adaptor 250. On the EoC transmission path (also referred as EoC transmitter or EoC TX), the ETX transcoder 310 receives the E-PHY TX signal 301 in the signal 241 and trans-codes it into the EoC TX signal 311.

There are various methods to trans-code the E-PHY TX signal into the EoC TX signal. In an embodiment of the present invention, the coax adaptor simply passes the MLT-3 coded E-PHY TX signal in 100Base-TX mode directly as the EoC TX signal without any change. In another embodiment, the coax adaptor decodes the MIT-3 modulation of the E-PHY TX signal, recovers the 125 MHz 1-bit signal and then re-modulates it into the BPSK signal for coax transmission. In yet another embodiment, the coax adaptor decodes the MLT-3 modulation of the E-PHY TX signal, recovers the 125 MHz 1-bit signal, then applies the trellis coded modulation to the 125 MHz 1-bit signal and produces the high-order of PAM modulated signal such as PAM-4T and PAM-8T for coax transmission. In yet another embodiment of the present invention, the coax adaptor decodes the MLT-3 modulation and the 4B5B encoding, and recovers the 100 MHz 1-bit payload signal. In a simple embodiment, the recovered 100 MHz 1-bit payload signal is re-modulated by BPSK modulation for coax transmission. In an advanced embodiment, the recovered 100 MHz 1-bit payload signal is re-encoded with the selected error correcting encoding and re-modulated to the chosen coax modulation method. As mentioned above, in a preferred embodiment, the re-encoder in the coax adaptor produces the output signal at the symbol rate that matches the bit rate of its incoming signal. This avoids the frame buffering and network delay.

In another preferred embodiment of the present invention, the signal is randomized to generate the EoC TX signal with flat spectrum when the payload bit stream is not or not completely uncorrelated.

In certain embodiment, the MUX 350 can pass either the EoC TX signal 311 or the CVBS signal 233 as its output into the signal 251 depending on whether the EoC connection is established or not. In one embodiment, the coax adaptor 250 establishes the coax connection after the certain pre-defined signal pattern is received from far-end coax adaptor in dual cable interface PHY 120. Initially after power up and whenever the coax connection is not established, the MUX 350 chooses to pass the CVBS 233 into the signal 251. Whenever the coax connection is established, the EoC TX signal transmission is enabled and the MUX 350 passes the EoC TX signal 311 through into the mixed EoC signal 251.

The portion of EoC TX signal included in the mixed EoC signal 251 is called the near-end EoC TX signal. The EoC TX signal from the far-end of coax penetrates the cable and arrives as the EoC RX signal. As stated above, since no multiplexed access mechanism is applied to control the EoC transmission at either end, the EoC RX signal is mixed together with the near-end EoC TX signal and the mixed EoC signal 251 is formed.

On the EoC receiving path (also referred as EoC receiver), based on the clean near-end EoC TX signal 311, the echo canceller 320 takes in the mixed EoC signal 251 and estimates the portion of the near-end EoC TX signal 311 included in the signal 251 by using the typical digital adaptive filtering technology such as the LMS (least mean square) adaptive filler. The echo canceller 320 subtracts the estimated portion away from the mixed EoC signal 251. The left signal 321 mainly contains the EoC RX signal. The coax equalizer 330 compensates for cable attenuation for the signal 321, and recovers the far-end EoC TX signal. The coax equalizer 330 is an adaptive filter, and can be either digital filter or analog filter. The ERX transcoder 340 demodulates the coax modulation decodes any coax error correcting encoding added by ETX transcoder 310 at the far-end, re-encodes the Ethernet encoding if that is decoded in far-end ETX transcoder 310, re-modulated with the Ethernet modulation such MLT-3 if that is demodulated in the far-end ETX transcoder 310, and recovers the E-PHY RX signal 302 in signal 241.

In certain embodiment of the present invention, the coax adaptor in dual interface PHY 120 at video recorder side is identical to coax adaptor 250 in IP camera 110 except a) there is no CVBS to multiplex with the EoC TX signal. b) the EoC TX signal transmission is always enabled, and C) a certain pre-defined signal pattern is periodically sent out to indicate its existence before the coax connection is established.

Although in the above embodiments of the invention, the dual cable interface PHY is described in the way where the separate conventional E-PHY is paired with the separate coax adaptor, the conventional E-PHY can be and is preferred to be tightly integrated with the presented coax adaptor in a practical design and the internal signals of the E-PHY are accessible to the coax adaptor. This allows more simplifications to further reduce the cost of the dual cable interface PHY without functional changes. In one embodiment, the 125 MHz 1-bit signals before the MLT-3 modulation is accessed, included in signal 241, and sent to the coax adaptor 250. The MLT-3 demodulation in ETX Transcoder 310 is avoided. Similar embodiments can be made in receiving path to avoid the MLT-3 re-modulation in ERX Transcoder 340. In another embodiment, the 100 MHz 1-bit signal before the 4B5B encoding in the E-PHY 240 or its equivalent signal is accessed, included in signal 241 and sent to the ETX transcoder 310 in the coax adaptor 250. The 4B5B encoder and MLT-3 demodulator in ETX Transcoder 310 are both avoided. Similar embodiments can be made in receiving path to avoid the 4B5B encoder and MLT-3 decoder in ERX Transcoder 340.

Although in the above embodiments of the invention, the coax adaptor is described in the way it is paired with the conventional E-PHY to make the dual cable interface PHY, a pair of the coax adaptors can be used alone to relay Ethernet over coax cable. In an embodiment, a conventional IP camera with Ethernet cable interface and RJ-45 connector only, is connected to the 1^{st} coax adaptor over 1^{st} Ethernet cable such as Cat5/6 UTP cable with the two Ethernet connectors, one at each end of the Ethernet cable. The 1^{st} coax adaptor is connected to the 2^{nd} coax adaptor over a coax cable via two coax connectors, one at each end of the coax cable. The 2^{nd} coax adaptor is connected to an Ethernet device such as NVR or Ethernet switch over 2^{nd} Ethernet cable via another two Ethernet connectors, one at each end of the 2^{nd} Ethernet cable. In this embodiment, the 1^{st} coax adaptor coverts two-way the E-PHY signal on the 1^{st} Ethernet cable to and from the mixed EoC signal on the coax cable while the 2^{nd} coax adaptor coverts two-way the E-PHY signal on the 2^{nd} Ethernet cable to and from the mixed EoC signal on the coax cable.

Further, multiple pairs of the coax adaptors can be used alone to relay an Ethernet connection repeatedly. In an embodiment, a conventional IP camera with Ethernet cable interface and RJ-45 connector only, is connected to the 1^{st} coax adaptor over 1^{st} Ethernet cable such as Cat5/6 UTP cable via the two Ethernet connectors. The 1^{st} coax adaptor is connected to the 2^{nd} coax adaptor over 1^{st} coax cable via two coax connectors. The 2^{nd} coax adaptor is connected to the 3^{rd} coax adaptor over 2^{nd} Ethernet cable via another two Ethernet connectors. The 3^{rd} coax adaptor is connected with 4^{th} coax adaptor over the 2^{nd} coax cable via another two coax connectors. The 4^{th} coax adaptor is connected to an Ethernet device such as NVR or Ethernet switch over 3^{rd} Ethernet cable via yet another two Ethernet connectors. In this embodiment, the 1^{st} coax adaptor coverts two-way the E-PHY signal on the 1^{st} Ethernet cable to and from the mixed EoC signal on the 1^{st} coax cable while the 2^{nd} coax adaptor coverts two-way the E-PHY signal on the 2^{nd} Ethernet cable to and from the mixed EoC signal on the 1^{st} coax cable. Similarly, the 3^{rd} coax adaptor coverts two-way the E-PHY signal on the 2^{nd} Ethernet cable to and from the mixed EoC signal on the 2^{nd} coax cable while the 4^{th} coax adaptor coverts two-way the E-PHY signal on the 3^{rd} Ethernet cable to and from the mixed EoC signal on the 2^{nd} coax cable.

It is to be noted that the camera of prior invention in [1] carries the CVBS analog video signal in baseband and the Ethernet over coax signal of the [1] in two passbands by using FDMA for multiplexed access control via the coax connector. The dual cable interface camera of present invention is functionally and structurally different in that it carries ether analog video signal or Ethernet over coax signal of present invention, but not both at same time, and all signals are carried in same band, typically in baseband, without any multiplexed access control.

It is to be noted that the camera of prior invention in [2] carries the CVBS analog video signal through the Ethernet connector in an IP camera in a way compatible to IEEE 802.3 standard. The dual cable interface camera of present invention is functionally and structurally different in that it carries the Ethernet over coax signal of the present invent, not CVBS analog video through the Ethernet connector. Further, the EoC signal of present invention can be carried through the Ethernet connector in a way incompatible with the IEEE 802.3 standard as the E-PHY signal and the EoC signal are required not to be carried at same time in present invention.

The present invention is described according to the accompanying drawings. It is to be understood that the present invention is not limited to such embodiments. Modifications and variations could be effected by those skilled in the art without departing from the spirit or scope of the invention as defined in the appended claims.

### REFERENCE

[1] US 2010/0194899 A1, MIXED FORMAT MEDIA TRANSMISSION SYSTEM AND METHODS, filed on Jan. 30, 2009
[2] U.S. Pat. No. 8,208,033 B2, VIDEO OVER ETHERNET, filed on Jul. 9, 2009

I claim:

1. A camera, comprising:
a processor system that receives an image signal from the image sensor and produces a plurality of video signals representative of the image signal, the video signals including a digital video signal and an optional analog video signal;
a dual physical layer transceiver that receives the said digital video signal and generates either the Ethernet physical layer transmitter signal or the Ethernet over coax transmitter signal;
an Ethernet connector including but not limited to the RJ-45 connector that carries either the said Ethernet physical layer transmitter signal or the said Ethernet over coax transmitter signal to the external Ethernet cable or coax cable; and
an optional coax connector including but not limited to the BNC connector that carries the said Ethernet over coax transmitter signal to the external coax cable, if the said optional coax connector is present in the camera.

2. The said camera of claim 1,
wherein the said Ethernet cable includes but is not limited to the Cat5, Cat5e or Cat6 unshielded twisted pair cable,
wherein the said digital video signal is transported over Internet Protocol in the forward Ethernet MAC frames,
wherein the said Ethernet physical layer transmitter signal is compliant to the IEEE 802.3 standard and is connected with the said Ethernet connector in the way compliant to the IEEE 802.3 standard, and is further carried over an external Ethernet cable if the external Ethernet cable is connected to the said Ethernet connector,
wherein the said Ethernet over coax transmitter signal is connected with the said Ethernet connector in a way compatible or incompatible with IEEE 802.3 standard, and is further carried over an external coax cable if the said external coax cable is connected to the said Ethernet connector either with or without an Ethernet connector to coax connector adaptor in between, and
wherein the said Ethernet over coax transmitter signal is connected with the said optional coax connector if the said optional coax connector is included in the camera, and is further carried over an external coax cable if the external coax cable is connected to the optional coax connector.

3. The said camera of claim 1,
wherein the said Ethernet connector receives the said external Ethernet physical layer receiver signal from the external Ethernet cable in a way compliant to IEEE 802.3 standard if the external Ethernet cable is connected with the said Ethernet connector, or
the said Ethernet connector receives the Ethernet over coax receiver signal from the external coax cable if the external coax cable is connected with the said Ethernet connector in a way compatible or incompatible with IEEE802.3 standard and with or without the Ethernet connector to coax connector adaptor in-between,
wherein the said optional coax connector receives the Ethernet over coax receiver signal from the external coax cable if the said optional coax adaptor is present the said camera,
wherein the said Ethernet over coax receiver signal and the said Ethernet over coax transmitter signal are both connected to and are naturally summed together to form the said mixed Ethernet over coax signal at either the Ethernet connector or the optional coax connector if the optional coax connector is present in the said camera,
wherein the said dual physical layer transceiver receives either the external Ethernet physical layer receiver signal from the said Ethernet connector, or the said mixed Ethernet over coax signal from either the said Ethernet connector or the said optional coax connector if the optional coax connector is present the said camera,
wherein the said dual physical layer transceiver recovers the backward Ethernet MAC frames from either the external Ethernet physical layer receiver signal or the said mixed Ethernet over coax signal, and
wherein the said processor system receives the said backward Ethernet MAC frames from the said dual physical layer transceiver and processes the said backward Ethernet MAC frames.

4. The said camera of claim 1, under some circumstances including but not limited to the case the said optional coax connector is present in the said camera but the said dual physical layer transceiver at the far-end of the external coax cable is not connected or not actively transmitting over the external coax cable,
wherein the said dual physical layer transceiver receives the said optional analog video signal if the said optional analog video signal is present, and passes the said optional analog video signal to either the said Ethernet connector or the said coax connector if the said coax connector is present in the said camera in same way the said Ethernet over coax transmitter signal is passed, and
wherein the said Ethernet over coax transmitter signal is not transmitted if the said optional analog video signal is transmitted.

5. The camera of claim 1, wherein the said dual physical layer transceiver, comprising:
a conventional Ethernet physical layer transceiver that is compliant to IEEE 802.3 standard, receives the said forward Ethernet MAC frames, and generates the said Ethernet physical layer transmitter signal; and
a coax adaptor that receives the said Ethernet physical layer transmitter signal, and generates the said Ethernet over coax transmitter signal.

6. The said dual physical layer transceiver of claim 5,
where in the said coax adaptor also receives the said mixed Ethernet over coax signal from either the said Ethernet connector or the said optional coax connector if the said optional coax connector is present in the said camera, and generates the internal Ethernet physical layer receiver signal, and
wherein the said conventional Ethernet physical layer transceiver also receives and decodes either the said external Ethernet physical layer receiver signal or the said internal Ethernet physical layer receiver signal, and recovers the said the said backward Ethernet MAC frames.

7. The said dual physical layer transceiver of claim 5,
wherein the said external Ethernet physical layer receiver signal is compliant with IEEE 802.3 standard, and
wherein the said internal Ethernet physical layer receiver signal is compliant with IEEE 802.3 standard.

8. The said dual physical layer transceiver of claim 5,
wherein the said external Ethernet physical layer receiver signal originates from a IEEE 802.3 standard compliant Ethernet device at the far-end of the external Ethernet cable, the Ethernet device including but not limited to a standalone conventional Ethernet physical layer transceiver or the said conventional Ethernet physical layer transceiver in the said dual physical layer transceiver in a DVR or Ethernet switch.

9. The said dual physical layer transceiver of claim 5,
wherein the said Ethernet over coax receiver signal originates from the said coax adaptor at the far-end of the external coax cable, either in a device including but not limited to a DVR with the said dual physical layer transceivers included, or standalone without the said conventional Ethernet physical layer transceiver in a device including but not limited to the Ethernet over coax relay box.

10. The said dual physical layer transceiver of claim 5,
Wherein, if the optional analog video signal is not provided, the coax adaptor receives the said Ethernet physical layer transmitter signal, generate and passes the said Ethernet over coax transmitter signal to the output, or
wherein, if the optional analog video signal is provided, the coax adaptor also receives the optional analog video signal, selects either the said Ethernet over coax transmitter signal or the optional analog video signal and passes the selected signal to the output.

11. The said dual physical layer transceiver of claim 5,
wherein the said coax adaptor may pass the said Ethernet physical layer transmitter signal as the said Ethernet over coax transmitter signal without any modification.

12. The said dual physical layer transceiver of claim 5,
Wherein the said coax adaptor may demodulate the Ethernet modulation applied in the said conventional Ethernet physical layer transceiver and re-modulate with the selected optional coax modulation while all Ethernet coding applied in the said conventional Ethernet physical layer transceiver remain unchanged.

13. The said dual physical layer transceiver of claim 5,
Wherein the said coax adaptor may demodulate the Ethernet modulation and decode some or all Ethernet coding applied in the said conventional Ethernet physical layer transceiver, then re-encode with the selected optional coax error correcting coding and re-modulate with the selected optional coax modulation.

14. The said dual physical layer transceiver of claim 5,
Wherein the said coax adaptor demodulates the selected optional coax modulation and decodes the selected optional coax error correcting coding applied in the said coax adaptor at the far-end of the external coax cable, then re-encodes with the Ethernet coding and re-modulates with the Ethernet modulation removed in the said coax adaptor at the far-end of the external coax cable to recover the said internal Ethernet physical layer receiver signal.

15. The said dual physical layer transceiver of claim 5,
wherein the said coax adaptor sends the said Ethernet over coax transmitter signal out on to the external coax cable without any multiplexed access control such as TDMA, FDMA, OFDMA or CDMA while the said coax adaptor at the far-end of the external coax cable transmits without any multiplexed access control either.

16. The said dual physical layer transceiver of claim 5,
wherein the said coax adaptor may be simplified without functional changes if the internal signals inside the said conventional Ethernet physical layer transceiver are accessible to the said coax adaptor when the said conventional Ethernet physical layer transceiver is tightly combined with the said coax adaptor, in the case including but not limited to
the case that the internal signals before the Ethernet modulation and after the Ethernet demodulation inside the said conventional Ethernet physical layer transceiver are provided to the said coax adaptor, and the selected optional Ethernet demodulation and the selected optional Ethernet re-modulation in the said coax adaptor are skipped, and
the case that the internal signals before some or all Ethernet encoding and after some or all Ethernet decoding inside the said conventional Ethernet physical layer transceiver are provided to the said coax adaptor, and the selected optional Ethernet decoding and the selected optional Ethernet re-encoding in the said coax adaptor are skipped.

17. A method for the said camera to carry Ethernet either over the external Ethernet cable or over the external coax cable, comprising:
generating the said forward Ethernet MAC frames that transport the said digital video signal in the said processor system,
generating the said Ethernet physical layer transmitter signal that carries the said forward Ethernet MAC frames in the said conventional Ethernet physical layer transceiver,
if the Ethernet is carried over the external Ethernet cable, sending the said Ethernet physical layer transmitter signal to the said Ethernet connector,
if the Ethernet is carried over the external Ethernet cable, receiving the said external Ethernet physical layer receiver signal from the said Ethernet connector,
if the Ethernet is carried over the external Ethernet cable, recovering the said backward Ethernet MAC frames from the said external Ethernet physical layer receiver signal in the said conventional Ethernet physical layer transceiver, and
processing the said backward Ethernet MAC frames in the said processor system.

18. The method of claim 17, further comprising:
if the Ethernet is carried over the external Ethernet cable, generating the said Ethernet over coax transmitter signal from the said Ethernet physical layer transmitter signal in the said coax adaptor,
if the Ethernet is carried over the external Ethernet cable, sending the said Ethernet over coax transmitter signal to either the said Ethernet connector or the said optional coax connector if the said optional coax connector is present in the said camera,
if the Ethernet is carried over the external Ethernet cable, receiving the said mixed Ethernet over coax signal either from the said Ethernet connector or from the said optional coax connector the said optional coax connector is present in the said camera,
if the Ethernet is carried over the external Ethernet cable, recovering the said internal Ethernet physical layer receiver signal from the said mixed Ethernet over coax signal in the said coax adaptor, and
if the Ethernet is carried over the external Ethernet cable, recovering the said backward Ethernet MAC frames from the said internal Ethernet physical layer receiver signal in the said conventional Ethernet physical layer transceiver.

19. A method to relay Ethernet over coax cable using a pair of coax adaptors connected with one coax cable, on the forward direction comprising:
at the 1^{st} said Ethernet connector, receiving the forward said external Ethernet physical layer receiver signal from the 1^{st} Ethernet cable that is connected to the 1^{st} said Ethernet connector,
at the 1^{st} said coax adaptor, receiving the forward said external Ethernet physical layer receiver signal from the 1^{st} said Ethernet connector and generating the forward said Ethernet over coax transmitter signal,
sending the forward said Ethernet over coax transmitter signal to the 1^{st} said coax connector and further on to the external coax cable,
at the 2^{nd} said coax connector, receiving the forward said mixed Ethernet over coax signal,
at the 2^{nd} said coax adaptor, generating the forward said internal Ethernet physical layer receiver signal from the forward said mixed Ethernet over coax signal, and
sending the forward said internal Ethernet physical layer receiver signal as the forward said Ethernet physical layer transmitter signal to the said 2^{nd} Ethernet connector and further on to the 2^{nd} Ethernet cable.

20. The said method of claim 19, on the backward direction further comprising:
at the said 2^{nd} Ethernet connector, receiving the backward said external Ethernet physical layer receiver signal from the 2^{nd} Ethernet cable that is connected to the 2^{nd} said Ethernet connector,
at the 2^{nd} said coax adaptor, receiving the backward said external Ethernet physical layer receiver signal from the 2^{nd} Ethernet connector and generating the backward said Ethernet over coax transmitter signal,
sending the backward said Ethernet over coax transmitter signal to the 2^{nd} said coax connector and further on to the external coax cable,
at the 1^{st} said coax connector, receiving the backward said mixed Ethernet over coax signal,
at the 1^{st} said coax adaptor, generating the backward said internal Ethernet physical layer receiver signal from the backward said mixed Ethernet over coax signal, and
sending the backward said internal Ethernet physical layer receiver signal as the backward said Ethernet physical layer transmitter signal to the 1^{st} said Ethernet connector and further on to the 1^{st} Ethernet cable.
